(19) United States
(12) Patent Application Publication
(10) Pub. No.: US 2008/0137136 A1
(43) Pub. Date: Jun. 12, 2008

(54) METHOD TO CONTROL PRINTER DRIVER AND NETWORK PRINT SYSTEM EMPLOYING THE SAME

(75) Inventor: Sung Ryong SHIN, Anyang-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/951,557

(22) Filed: Dec. 6, 2007

(30) Foreign Application Priority Data
Dec. 7, 2006 (KR) 2006-123934
Oct. 17, 2007 (KR) 2007-104312

(51) Int. Cl. G06F 3/12

(52) U.S. Cl. 358/1.15

(57) ABSTRACT

A method to control a printer driver and a network print system employing the same. Print options of a printer driver, which have been set to suit a server device connected to a printer, and data files linked to the print options are transmitted to each client device connected to the server device through a network using an OS. This eliminates the inconvenience of having to again set print options of the printer driver in each client device, thereby increasing the convenience of use. The authority to use each selectable item of a specific print option function in print options is also set, thereby making it possible to limit the use of the specific item, thereby extending available functions.

### CROSS-REFERENCE TO RELATED APPLICATIONS

This application claims the benefit of Korean Patent Application No. 2006-123934, filed in the Korean Intellectual Property Office on Dec. 7, 2006 and No. 2007-104312, filed in the Korean Intellectual Property Office on Oct. 17, 2007, the disclosures of which are incorporated herein by reference.

### BACKGROUND OF THE INVENTION

1. Field of the Invention

Aspects of the present invention relate to a method to control a printer driver and a network print system employing the same, and more particularly, to a method to control a printer driver and a network print system employing the same, wherein a server device connected to an image forming apparatus (for example, a printer) can perform print drive setting of each client device that is connected to the server device through a network.

2. Description of the Related Art

To perform printing using a printer, it is generally necessary to connect the printer to a computer and to install a printer driver of the printer on the computer. However, the efficiency of use of the printer is low if only one computer is connected to the printer, because the printer can only be used by the single computer. Most companies thus connect a number of client devices to a server device, and connect a printer to the server device through a local area network to allow each of the client devices to use the printer.

To allow each client device to use the printer, it is necessary to install a printer driver on the client device. Generally, the printer driver is manually installed on the client device by using a storage medium (such as a floppy disk or CD) in which the printer driver is stored as a setup file, or by downloading the printer driver over the Internet.

In recent systems, to eliminate the inconvenience of having to manually install the printer driver, a printer driver installed on a server device connected to a printer is automatically downloaded to and installed on each client device by connecting the client device to the server device through a network.

However, since the server device provides only the printer driver to each client device, to make the printer driver print option environment of each client device identical to that of the server device, it is necessary for the manager to operate each client device to individually set print options (such as paper size, paper type, paper tray addition, watermark, and overlay options) on a print option setup window of the printer driver. The need to set the print options one by one reduces the convenience of use.

### SUMMARY OF THE INVENTION

Aspects of the invention provide a printer driver and a network print system employing the same, wherein a server device with a printer driver installed to drive an image forming apparatus can provide print options of the printer driver to each client device.

Additional aspects of the invention provide a printer driver and a network print system employing the same, wherein a server device with a printer driver installed to drive an image forming apparatus can provide print options of the printer driver and data files linked to the print options to each client device.

Additional aspects and/or advantages of the invention will be set forth in part in the description which follows and, in part, will be obvious from the description, or may be learned by practice of the invention.

According to an aspect of the present invention a method to control a printer driver to drive an image forming apparatus connected to a server device is provided. The method includes checking a print option set in the printer driver; and transmitting the print option to a plurality of client devices connected to the server device so as to set print options of the client devices to be the same as the print options of the printer driver.

According to another aspect of the present invention, the checking of the print option comprises checking the print option in a registry of an operating system of the server device.

According to another aspect of the present invention, the transmitting of the print option comprises transmitting the print option when the client devices are connected to the server device through a network.

According to another aspect of the present invention, the transmitting of the print option comprises copying the print option from the server device and transmitting the copied print option to the client device.

According to another aspect of the present invention, the transmitting of the print option comprises generating a self-installable executable file capable of automatically setting the print option, and transmitting the generated executable file to the client device.

According to another aspect of the present invention, the print option includes at least one of overlay, watermark, double-sided printing, layout, paper size, paper type, paper source, and resolution options.

According to another aspect of the present invention, a method to control a printer driver to drive an image forming apparatus connected to a server device is provided. The method comprises checking a print option of the printer driver and a data file linked to the print option; and transmitting the print option and the data file to a plurality of client devices connected to the server device.

According to another aspect of the present invention, the method further comprises displaying an item requiring authority setting and setting an authority to use the displayed item before checking the print option and the data file.

According to another aspect of the present invention, the setting of the authority comprises setting the authority to use the displayed item according to an authority of a manager who has logged into a corresponding device.

According to another aspect of the present invention, the item requiring authority setting comprises at least one of an overlay item and a watermark item.

According to another aspect of the present invention, the checking of the print option and the data file comprises checking the print option and the data file linked to the print option in a registry of an operating system of the server device.

According to another aspect of the present invention, the transmitting of the print option and the data file comprises transmitting the print option and the data file when the client device is connected to the server device through a network.

According to another aspect of the present invention, the transmitting of the print option and the data file comprises copying the print option and the data file from the server device and transmitting the copied print option and data file to the client device.

According to another aspect of the present invention, the transmitting of the print option and the data file comprises generating a self-installable executable file capable of automatically setting the print option and the data file and transmitting the generated executable file to the client device.

According to another aspect of the present invention, a network print system is provided. The network print system comprises a server device with a printer driver installed on the server device; and a plurality of client devices connected to the server device, wherein a print option of the printer driver is transmitted from the server device to each of the client devices to set print options of the plurality of client devices.

According to another aspect of the present invention, a network print system is provided. The network print system comprises a server device with a printer driver installed on the server device; and a plurality of client devices connected to the server device, wherein a print option of the printer driver and a data file linked to the print option are transmitted from the server device to each of the client devices to set print options of the plurality of client devices.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a schematic configuration of a network print system according to an embodiment of the invention;

FIG. 2 is a schematic control block diagram of a server device shown in FIG. 1;

FIG. 3 illustrates a memory map of the RAM shown in FIG. 2;

FIGS. 4 to 12 illustrate examples of respective print option setup windows of function menus of the printer driver according to an embodiment of the invention;

FIG. 13 is a control flow chart illustrating a procedure in which print options of a printer driver are set according to a command from a manager according to an embodiment of the invention;

FIG. 14 is a control flow chart illustrating a procedure in which print options of the printer driver, which have been set to suit the server device, are automatically set in a client device according to an embodiment of the invention;

FIG. 15 is a control flow chart illustrating a procedure in which the authority to use an overlay item of an overlay print function is set in the printer driver, according to an embodiment of the invention; and

FIG. 16 illustrates a window to set the authority to view the overlay item in FIG. 15 according to an embodiment of the invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

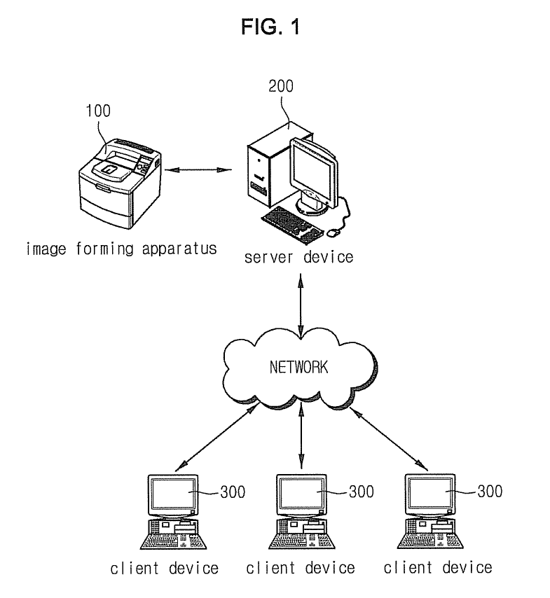

FIG. 1 shows a schematic configuration of a network print system according to an embodiment of the invention. The network print system includes an image forming apparatus 100, a server device 200, and multiple client devices 300. For ease of explanation, the image forming apparatus 100 is limited to a printer in the following description. However, the image forming apparatus may be any apparatus capable of forming an image onto a printable medium, such as a copier, facsimile machine, or multifunction device.

The printer 100 is connected to the server device 200 through a printer cable. A printer driver to drive the printer 100 is installed on the server device 200. When a client device 300 is connected to the server device 200 through a network, the server device 200 transmits print options of the printer driver, which have been set to suit the server device 200, to the client device 300 according to a command of the printer driver.

The client device 300 is connected to the server device 200 through the network and can use the printer 100 connected to the server device 200. The client device 300 receives the print options of the printer driver transmitted from the server device 200 so that a printer driver of the client device 300 is automatically set to the same print option environment as that of the printer driver installed on the server device 200, without the manager individually setting the print options of the printer driver of the client device 300.

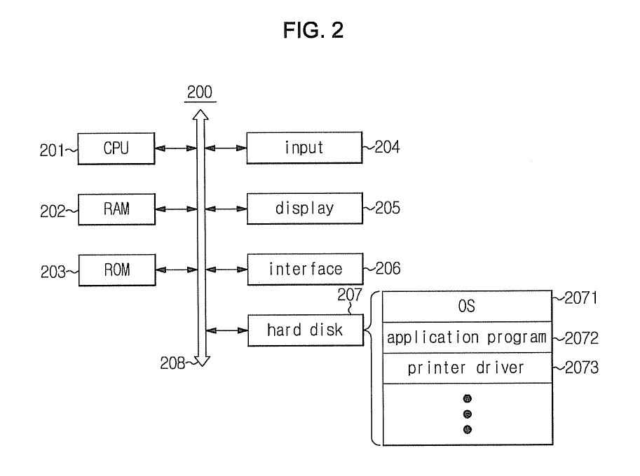

As shown in FIG. 2, the server device 200 includes a CPU 201, a RAM 202, a ROM 203, an input unit 204, a display unit 205, an interface unit 206, a hard disk 206, and a system bus 208 through which each of the components communicates data with each other. According to other aspects of the invention, the server device 200 may include additional and/or different components. Similarly, the functionality of two or more of the above components may be integrated into a single unit.

The CPU 201 controls the overall operations of the various components connected to the system bus 208 according to programs stored in the RAM 202. The RAM 202 functions as a main memory for the CPU 201. The ROM 203 stores various programs and data. The ROM 203 has various storage regions to store the various programs and data. These storage regions include a font region to store various font data, a program region to store a boot program or BIOS, and a data region to store various data.

The input unit 204 controls commands or data inputs through a keyboard, mouse, or other input device. The display unit 205 displays a user interface (UI) window on a display to inform the manager of program execution states or results. The interface unit 206 controls an interface with the printer 100 or each client device 300.

The hard disk 207 is an external memory to store an operating system (OS) 2071, various application programs 2072 (for example, a word processing program that processes documents containing text, figures, and tables), and a printer driver 2073, which is a print processing program. The printer driver 2073 converts a document created by the application program 2072 into print data. When a print operation is performed, the printer driver 2073 causes the display unit 205 to display a print option setup window for print option setup of the printer driver 2073 to allow the manager to set desired print options through the input unit 204.

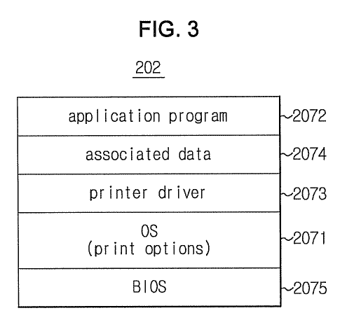

FIG. 3 shows a memory map of the RAM 202 of the server device 200 in which print options, an associated program, etc., are stored after the application program 2072 and the printer driver 2073 are executed. As shown in FIG. 3, a BIOS 2075, the OS 2071, the application program 2072, the printer driver 2073, and associated data 2074 are loaded into the RAM 202. The BIOS 2075 allows execution of the application program 2072 and the printer driver 2073.

Print options of the printer driver 2073 are stored in the OS region 2071 in the RAM 202. The print options of the printer driver 2073 include various print options through which print methods of the printer 100 are specified on the application program 2072. For example, the print options of the printer driver 2073 include layout options, paper options, graphics options, and additional function (extras) options. Layout options include paper orientation and double-sided printing options. Paper options include paper type, size, and feed source options. Graphics options include resolution and toner save options. The additional function (extras) options include watermark and overlay options. These print options are updated each time the manager changes a print option through the printer driver.

The printer driver 2073 displays a print option setup window with reference to print option information stored in the OS region 2071 according to a command from the manager. On the print option setup window, the manager can change default print options to change them to desired print options. If the manager changes print options through the printer driver 2073, the printer driver 2073 updates print options stored in the OS region 2071 according to the change. A region in the OS 2071 where print options are stored is generally referred to as a registry. The term “registry” will be used to refer to such a region in the following description.

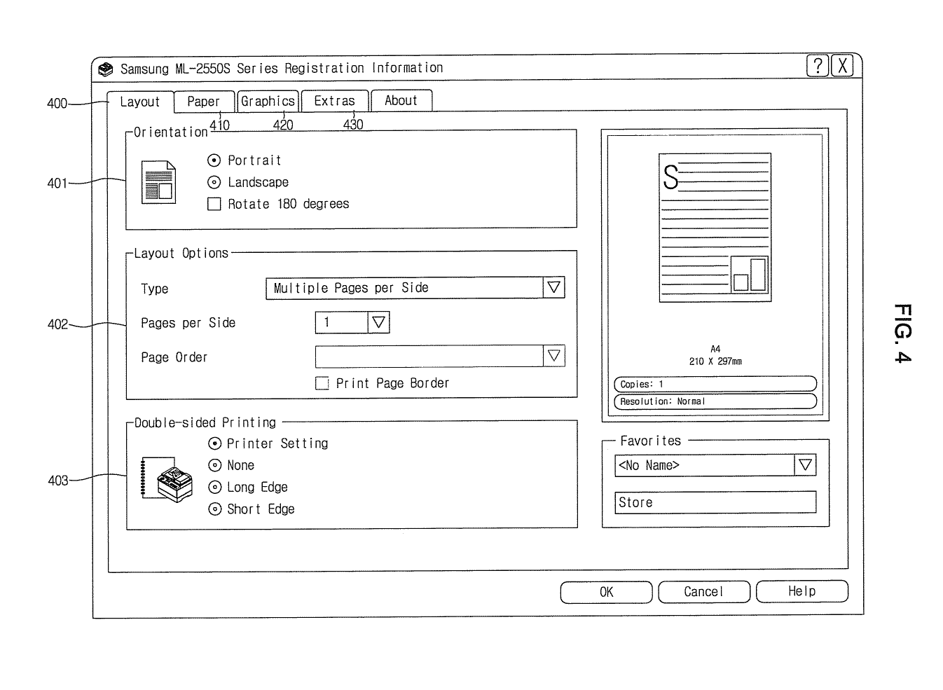

FIGS. 4 to 12 show examples of respective print option setup windows of print option menus of the printer driver 2073. As shown in FIG. 4, the top of the print option setup window is designed to allow the manager to select function menus 400-430. The function menus 400-430 include a layout menu 400, a paper menu 410, a graphics menu 420, and an additional function (extras) menu 430. Defaults are displayed in each option box in each of the function menus 400-430.

When the layout menu 400 is selected, option boxes, such as a paper direction box 401, a layout setup box 402, and a double-sided printing box 403, are displayed in the window. The layout setup box 402 allows the manager to select the orientation of paper for printing, such as a horizontal (landscape) orientation or a vertical (portrait) orientation, or to rotate the orientation of paper by 180 degrees. Through the option boxes, the manager can set desired print options such as paper orientation, layout setup, and double-sided printing options.

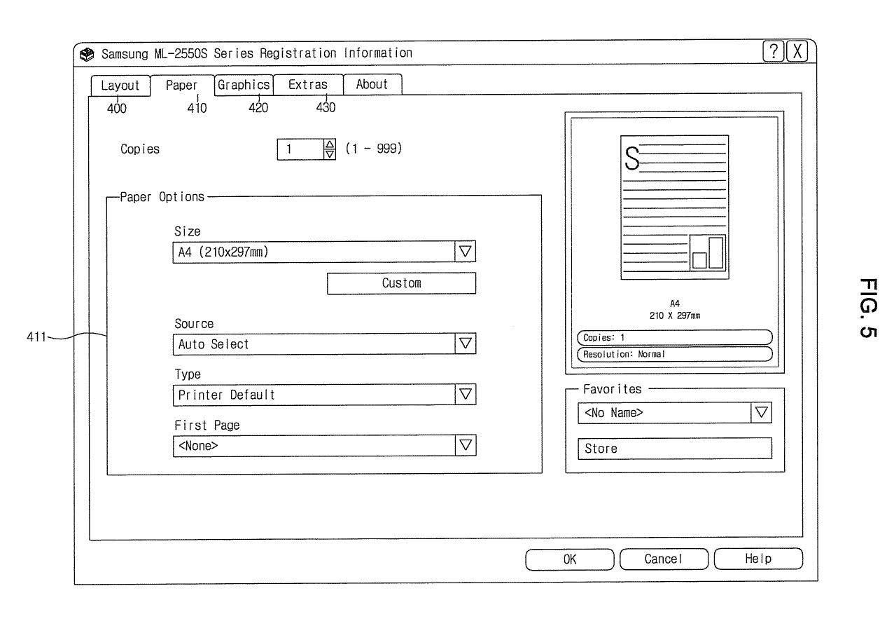

When the paper menu 410 is selected from the function menus 400-430 as shown in FIG. 5, a paper option box 411 is displayed in the window. The paper option box 411 allows the manager to select a paper size (such as A4 (201×297 mm) or A5 (148×210 mm)), a paper source (such as manual feed or auto select), and a paper type (such as normal paper or thick paper). Accordingly, through the paper option box 411, the manager can set desired print options, such as the paper options.

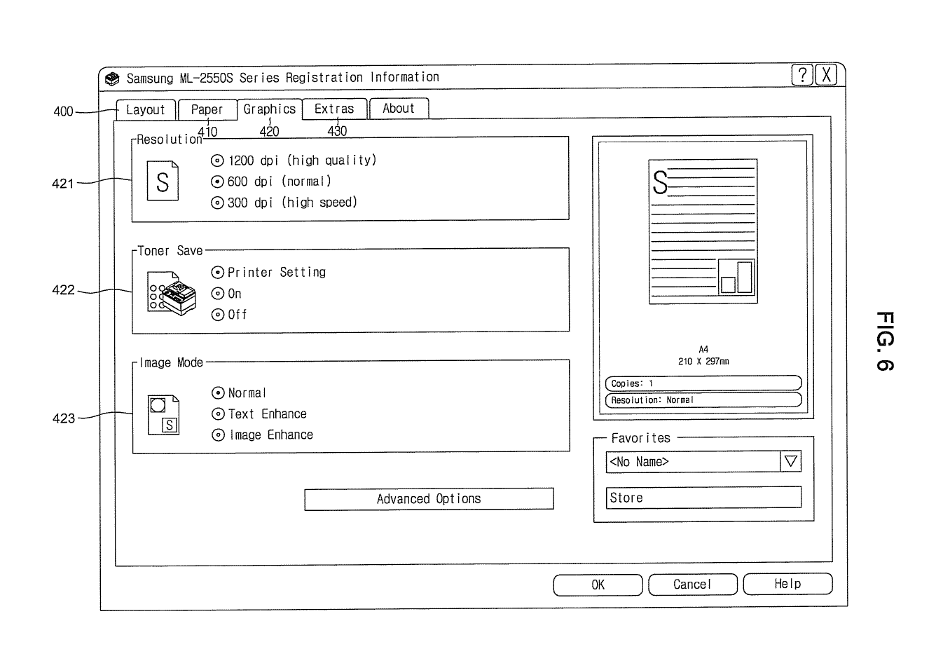

When the graphics menu 420 is selected from the function menus 400-430 as shown in FIG. 6, a resolution box 421, a toner save box 422, and an image mode box 423 are displayed in the window. The resolution box 421 allows the manager to select a. print resolution, such as 1200 dpi, 600 dpi, or 300 dpi. The toner save box 422 allows the manager to select whether to enable or disable a toner save mode. The image mode box 423 allows the manager to select whether to selectively enhance text or image resolution. Thus, through the graphics option boxes 421, 422, and 423, the manager can set desired print options such as the resolution, toner save, and image mode options.

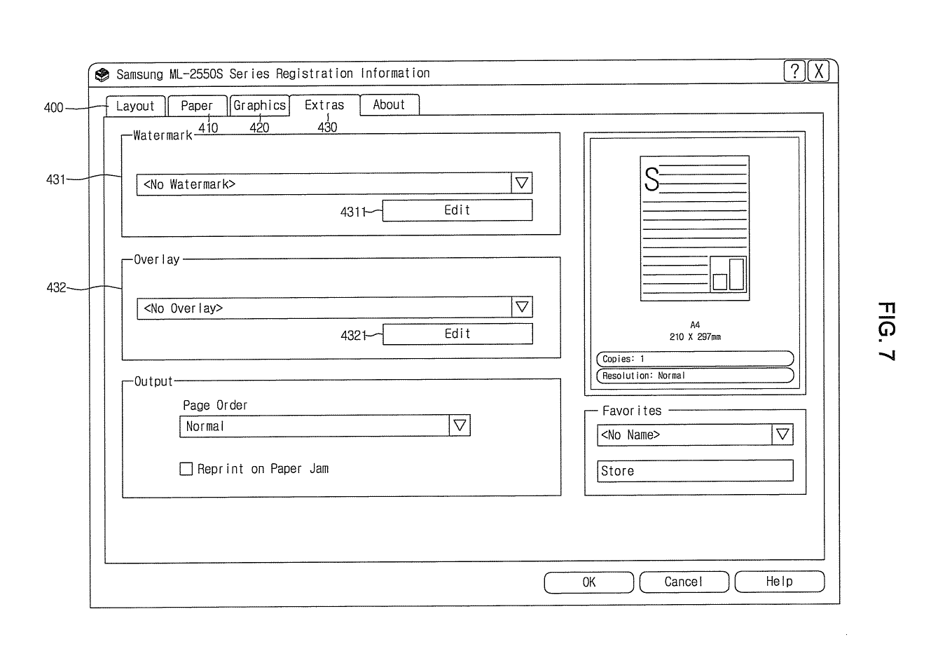

When the extras menu 430 is selected from the function menus 400-430 as shown in FIG. 7, a watermark box 431 and an overlay box 432 are displayed in the window. The watermark box 431 allows the manager to select a watermark item from a list of various watermark items used for secure printing. The overlay box 432 allows the manager to select an overlay item from a list of various overlay items such as a logo or a print form used for overlay printing.

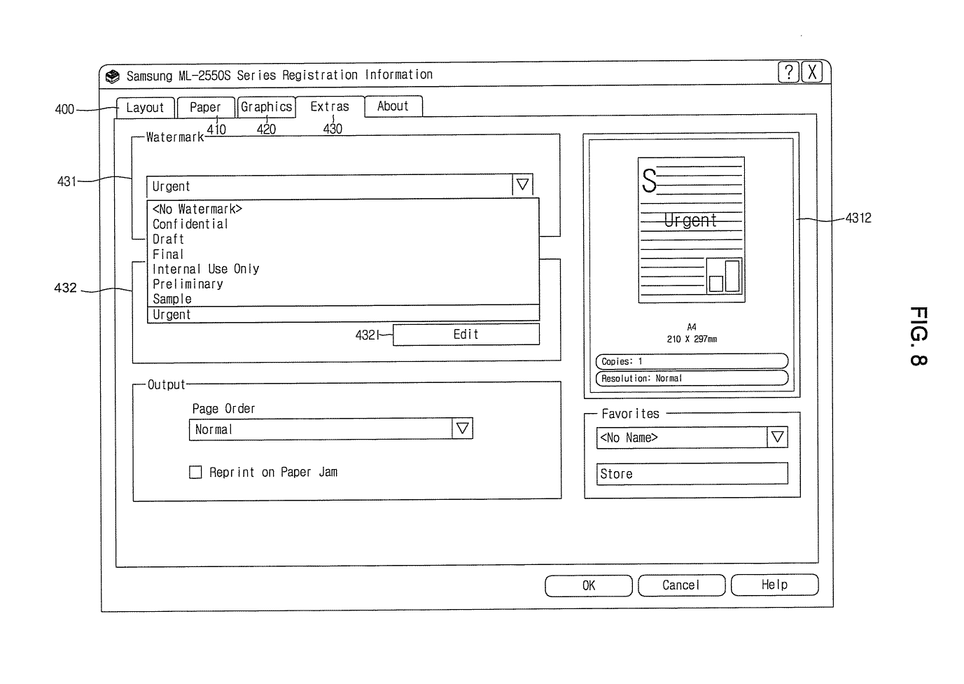

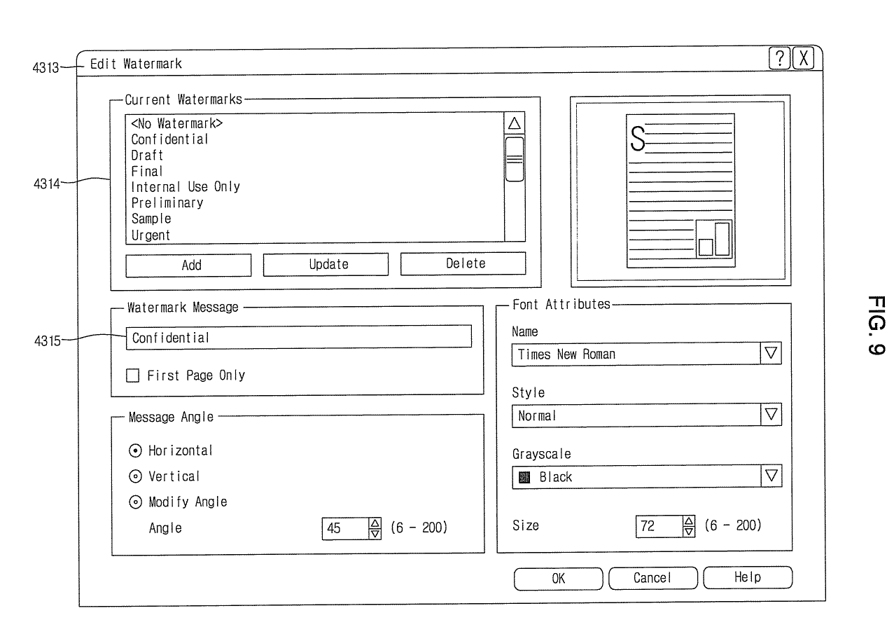

As shown in FIG. 8, the watermark box 431 has a list of watermark items including Confidential, Draft, Final, etc., as defaults. A corresponding watermark word is displayed in a preview box 4312 each time an item is selected. When the manager presses an edit button 4311 in the watermark box 431, as shown in FIG. 7, a watermark edit window 4313 is displayed as shown in FIG. 9. Through a watermark message box 4315, the manager can edit the watermarks items displayed in a watermark edit box 4314 in the watermark edit window 4313.

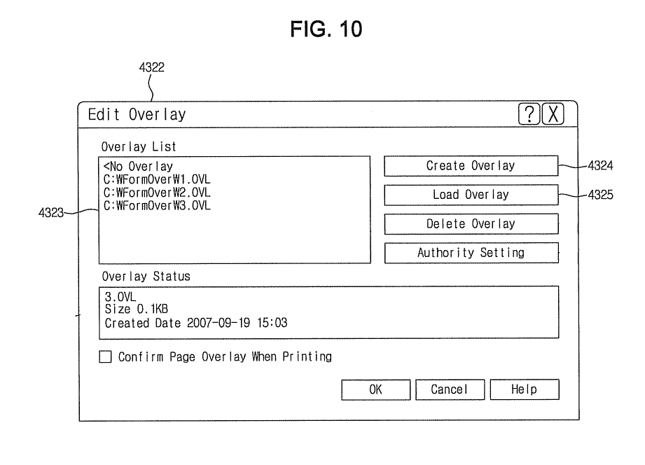

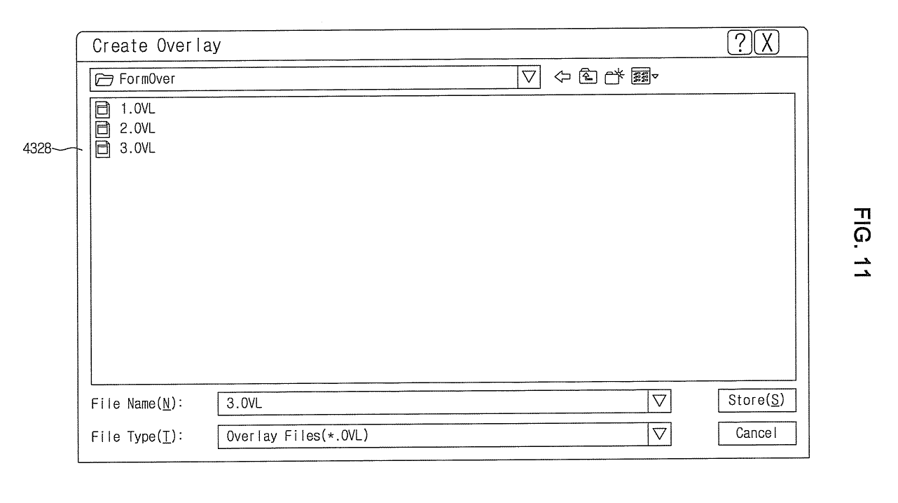

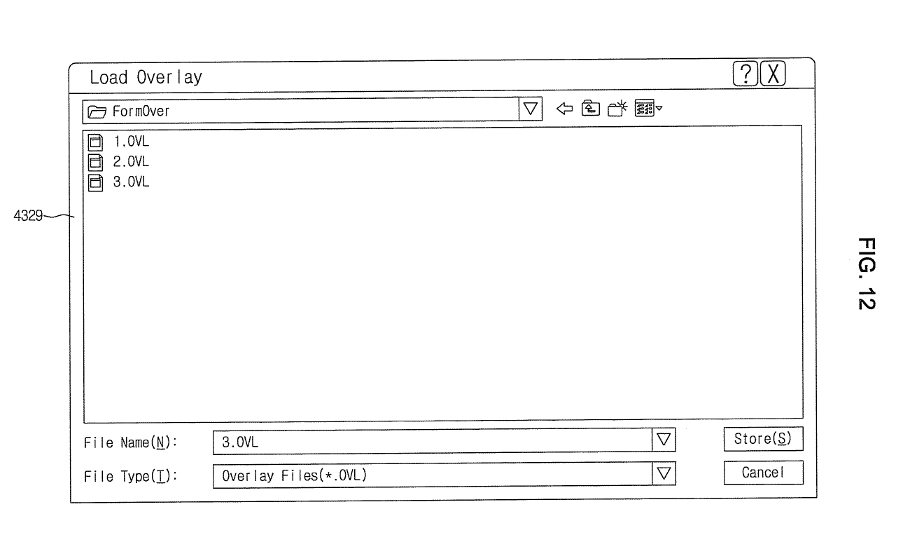

When the manager presses an edit button 4321 in the overlay box 432 in FIG. 7, an overlay edit window 4322 is displayed as shown in FIG. 10. A previously created list of overlay items is displayed in an overlay list box 4323 in the overlay edit window 4322. An overlay item is added to the overlay list in the following manner. When a create overlay button 4324 is pressed, a create overlay window 4328 is displayed, as shown in FIG. 11. When printing is performed after a desired file name is entered on the create overlay window 4328, an overlay file having the entered file name is stored in a folder named “FormOver” and the corresponding overlay item is added to the overlay list. FIG. 12 shows a window 4329 displayed when a load overlay button 4325 is pressed on the overlay edit window 4322 of FIG. 10. In this manner, the manager can set desired print options, such as the watermark and overlay options.

The print options previously stored in the registry of the OS 2071 are replaced with the print options that the manager has set as described above with reference to FIGS. 4 to 12. The updated print options are applied to the next printing.

In order to set the same print options as those of the printer driver installed on the server device 200 to the printer driver of each client device 300 in the server/client environment, in which each client device 300 is connected to the server device 200 connected to the printer 100 through the network as described above, the manager needs to individually set print options in each option box of each function menu on the print option setup window displayed by the printer driver of each client device 300. Although it consumes a small amount of time and effort if a small number of client devices 300 are provided, the manual setup by the manager is inefficient if a large number of client devices are provided.

Thus, according to an embodiment of the invention, the printer driver print options set to suit the server device 200 are provided to the client device 300 in order to automatically set the same print option environment to the two printer drivers of the server device 200 and the client device 300.

For example, when a client device 300 is connected to the server device 200 through the network to install or update a printer driver on the client device, the printer driver installed on the server device 200 copies and sends print options registered in the registry in the OS 2071 to the client device 300. The print options stored in the OS region 2071 of the server device are copied and transmitted to the client device 300 to update print options stored in the OS region of the client device 300. In this manner, the print options of the printer driver installed on the client device 300 are automatically set to be identical to those of the server device 200.

In some print option functions of the print option setup window of the printer driver, a separate data file linked to the print options may be stored together with the print options in the hard disk 207. In this case, the client device 200 will not operate correctly with the print option function linked to the data file, since the data file linked to the print options is not transmitted to the client device 300. Typical examples of such a print option function include an overlay print function and a watermark print function.

In the overlay print function, an overlay file corresponding to an overlay item, which the manager selects from a list of overlay items corresponding to overlay files that have been previously stored by default or have been previously created and stored with the application program 2072 for overlay printing, is loaded and overlay printing is performed using the loaded overlay file when print data is printed by the printer 100. The overlay file stores a specific form such as a print form or a specific image such as a logo applied as a background when print data is printed.

The following is a more detailed description of the overlay print function. In order to create an overlay file from a document of a logo, a print form, or the like for use in overlay printing, the manager first presses the edit button 4321 on the overlay box 432 of the extras menu 430 in the window of FIG. 7 to display the overlay edit window 4322 of FIG. 10. The manager then presses the create overlay button 4324 in the overlay edit window 4322 to display the create overlay window 4328 shown in FIG. 11, and enters a desired file name on the create overlay window 4328. When printing is performed after the desired file name is entered, an overlay item having the entered file name is added to the corresponding print option and an overlay file created on the window 4328 is separately stored in a folder named “FormOver” in the hard disk 207. If the server device 200 provides only the print option to the client device 300, the data file linked to the overlay item is not copied from the “FormOver” folder in the hard disk 207 of the server device 200 to a “FormOver” folder in the hard disk of the client device 300 although the overlay item is present in the print option setup screen of the printer driver of the client device 300, so that overlay printing is not normally performed.

Accordingly, for this print option function, it is necessary to transmit not only the print option but also data files linked to the print option to the client device 300. Thus, the print option stored in the OS region of the client device 300 is updated with the print option transmitted from the server device 200. The data files linked to the print option are copied to and stored in the “FormOver” folder in the hard disk of the client device 300, so that overlay printing is normally performed.

In the watermark print function, data files corresponding to watermark items to be used are provided separately and stored in a folder in the hard disk 207. The same procedure as that of the overlay print option function described above can be applied to the watermark print function in which data files corresponding to a list of watermark items to be used are separately provided and stored in a folder in the hard disk.

The following is a detailed description of a procedure in which the printer driver installed on the server device sets print options according to a command from the manager according to an embodiment of the invention.

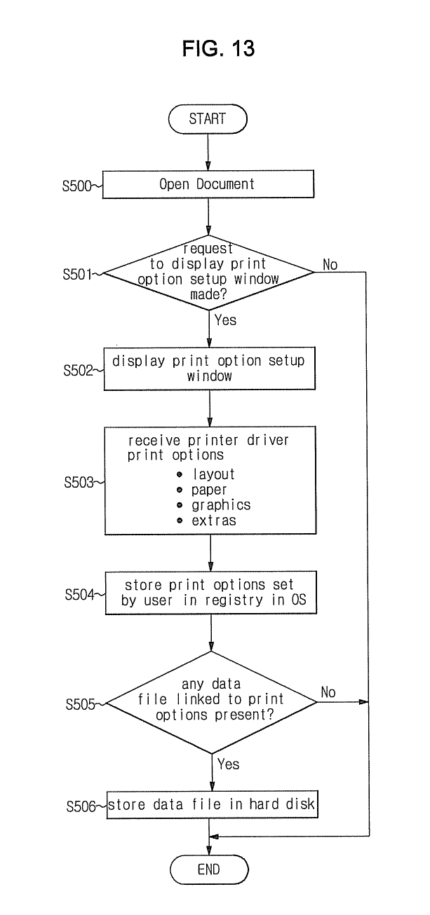

As shown in FIG. 13, when the manager opens a document to be printed, the printer driver installed on the server device 200 checks whether the manager has made a request to display a print option setup window in operations S500 and S501. The printer driver displays the print option setup window according to the display request from the manager in operation S502. The printer driver receives respective print options of various function menus, such as “layout”, “paper”, “graphics”, and “extras”, from the manager in operation S503. The printer driver then stores a print option entered by the manager in the registry of the OS 2071 of the server device 200 in operation S504. The printer driver determines whether any data file linked to the print option has been stored in the hard disk 207 in operation S505. If any data file linked to the print option has been stored, the printer driver stores the data file at a storage location of a specified path in the hard disk 207 in operation S506. In this manner, the set print option and the data file linked to the print option are stored at the specified storage location, thereby completing the printer driver print option setup.

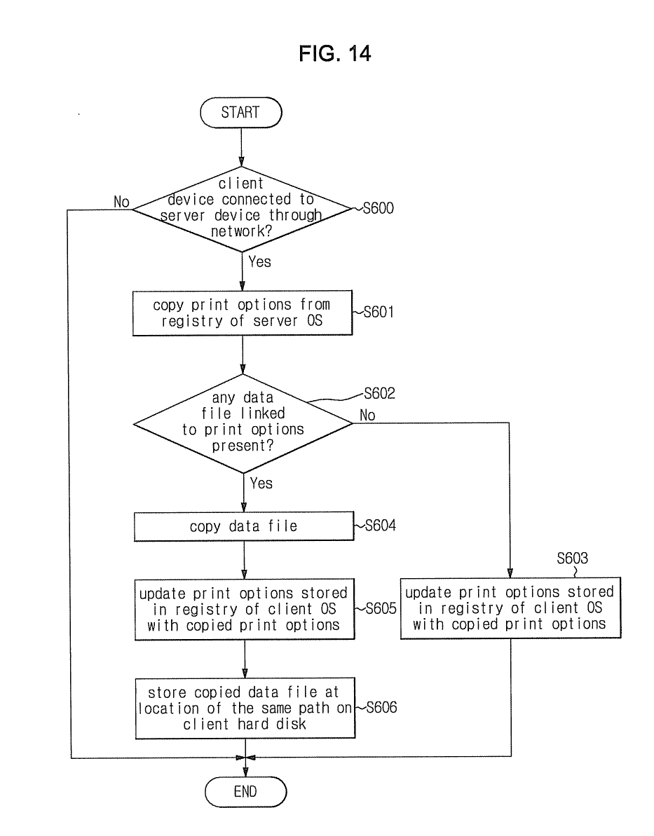

Reference will now be made to a procedure in which print options of the printer driver, which have been set to suit the server device 200, are automatically set in the printer driver of the client device 300 by transmitting the print options alone or together with data files linked to the print options from the server device 200 to the client device 300. As shown in FIG. 14, first, whether the client device 300 is connected to the server device 200 through the network in order to install or update a printer driver on the client device is determined at operation S600.

If the client device 300 is connected to the server device 200 through the network, print options registered in the registry of the OS 2071 are copied in operation S601. After the print options are copied, whether any data file linked to the print options has been stored in the hard disk 207 of the server device 200 is determined at operation S602. If no data file linked to the print options has been stored, print options stored in the registry of the OS of the client device 300 are updated with the copied print options in operation S603.

If a data file linked to the print options has been stored, the data file is copied in operation S604. After the data file is copied, print options stored in the registry of the OS of the client device 300 are updated with the copied print options in operation S605. The copied data file is also stored in the hard disk of the client device 300 at the storage location of the same path as the original path of the data file in the server device 200 in operation S606. In this manner, the print options of the printer driver of the server device 200 are automatically set in the client device 300, and the data file linked to the print options can be used in the client device 300 so that all print option functions can be performed normally.

In the above embodiment, print options of the printer driver of the server device 200 and data files linked to the print options are copied and transmitted to the client device 300 so that the print options and the data files are stored in the client device 300 at a storage location of the same path as that of the server device 200. The invention is not limited to this embodiment. For example, a self-installable executable (exe) file may be created by checking (or referring to) print options in the printer driver and data files linked to the print options and then may be transmitted to the client device 300 so that the exe file is self-installed in the client device to automatically set the print options in the client device.

When there is a need to limit the use of each item of each setup box of each function menu on the print option setup window, it may be necessary to limit the authority to view the item. The view authority is determined by the authority of a manager, who has logged into the client device 300, to use the client device 300. The manager may be a system manager who can change all functions of the system or a power user who can change some functions of the system. The system manager may be allowed to view all items and the power user may be allowed to view authorized items only.

If the authority to use each item of a print function that requires authority setting is set to limit the authority to view the item when the corresponding print option is set, then the authority of the manager of a client device, to which the same print option has been automatically set, to view the item of the print option is also limited, thereby limiting the use of the item of the print option. This view authority setting is more effective, especially in limiting the use of a specific overlay item in the overlay print function.

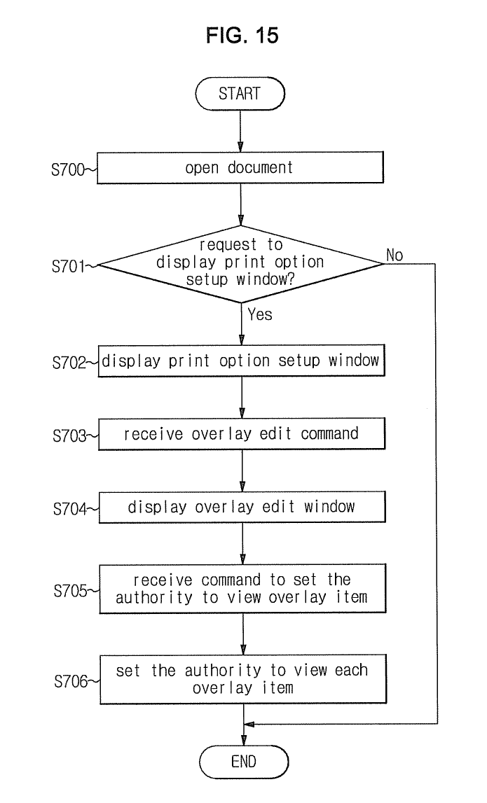

Reference will now be made to a procedure to limit the viewing of an overlay item in the overlay print function. As shown in FIG. 15, when the manager opens a document to be printed on the application program 2072, whether the manager has made a request to display the print option setup window is determined in operations S700 and S701.

The print option setup window is displayed if a request has been made to display the print option setup window in operation S702. An overlay edit command is received from the manager after the print option setup window is displayed in operation S703. The overlay edit window 4322 shown in FIG. 10 is then displayed to allow an overlay to be edited according to an overlay edit command from the manager in operation S704.

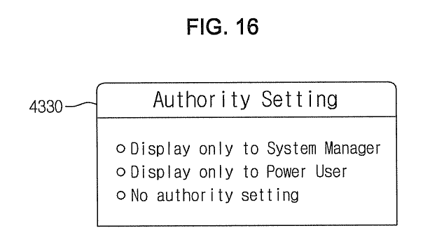

A command to set the authority to view an overlay item is received from the manager after the overlay edit window 4322 is displayed in operation S705. If the manager presses an authority setting button after selecting an overlay item that the manager desires to set the authority to view in the overlay list box 4323, then an authority setup window 4330 is displayed to allow the manager to set the authority to view the selected overlay item as shown in FIG. 16. On the authority setup window 4330, the manager selects whether to allow only the system manager to view the selected overlay item, whether to allow only the power user to view the selected overlay item, and/or whether to set no authority level. In this manner, the manager sets the authority to view the selected overlay item, thereby setting the authority to use the selected overlay item.

After a command to set the authority to view an overlay item is received, the authority setting selected by the manager for each overlay item is applied to set the authority to view each overlay item. The printer driver updates the overlay print function of the print option registered in the registry of the OS 2071 and stores the authority information set for each overlay item together with the updated information.

When the print options of the client device 300 are automatically set, print option information, including each overlay item for which the authority to view has been set, is also automatically set. Accordingly, it is possible to limit the viewing of each overlay item according to the authority of the logged-in manager to view the overlay item not only in the server device 200 but also in the client device 300, thereby limiting the use of the overlay print of each overlay item. Overlay items are not displayed to a manager who has no authority to view the overlay items. In addition, each overlay item is displayed to a manager who has the authority to view the overlay item, and the manager can normally use the overlay function of the overlay item since an overlay file, to which the overlay item refers, is also copied to the client device 300.

As is apparent from the above description, the present invention has a variety of advantages. For example, print options of a printer driver, which have been set to suit a server device 200 connected to an image forming apparatus, and data files linked to the print options are provided to each client device to eliminate the inconvenience of the manager having to again set print options in each client device in order to set the same print option environment as that of the printer driver of the server device to the printer driver of the client device, thereby increasing the convenience of use. In addition, the authority to use each selectable item of a specific print option function in print options is set, thereby making it possible to limit the use of the specific item, thereby extending the available functions.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method to control a printer driver to drive an image forming apparatus connected to a server device, the method comprising:
checking a print option set in the printer driver; and
transmitting the print option to a plurality of client devices connected to the server device so as to set print options of the client devices to be the same as the print options of the printer driver.

2. The method according to claim 1, wherein the checking of the print option comprises checking the print option in a registry of an operating system of the server device.

3. The method according to claim 1, wherein the transmitting of the print option comprises transmitting the print option when the client devices are connected to the server device through a network.

4. The method according to claim 3, wherein the transmitting of the print option comprises copying the print option from the server device and transmitting the copied print option to the client device.

5. The method according to claim 3, wherein the transmitting of the print option comprises:
generating a self-installable executable file capable of automatically setting the print option; and
transmitting the generated executable file to the client device.

6. The method according to claim 1, wherein the print option includes at least one of overlay, watermark, double-sided printing, layout, paper size, paper type, paper source, and resolution options.

7. A method to control a printer driver to drive an image forming apparatus connected to a server device, the method comprising:
checking a print option of the printer driver and a data file linked to the print option; and
transmitting the print option and the data file to a plurality of client devices connected to the server device.

8. The method according to claim 7, further comprising:
displaying an item requiring authority setting; and
setting an authority to use the displayed item before checking the print option and the data file.

9. The method according to claim 8, wherein the setting of the authority comprises setting the authority to use the displayed item according to an authority of a manager who has logged into a corresponding device.

10. The method according to claim 8, wherein the item requiring authority setting includes at least one of an overlay item and a watermark item.

11. The method according to claim 7, wherein the checking of the print option and the data file comprises checking the print option and the data file linked to the print option in a registry of an operating system of the server device.

12. The method according to claim 7, wherein the transmitting of the print option and the data file comprises transmitting the print option and the data file when the client device is connected to the server device through a network.

13. The method according to claim 12, wherein the transmitting of the print option and the data file comprises copying the print option and the data file from the server device and transmitting the copied print option and data file to the client device.

14. The method according to claim 12, wherein transmitting of the print option and the data file comprises:
generating a self-installable executable file capable of automatically setting the print option and the data file; and
transmitting the generated executable file to the client device.

15. The method according to claim 7, wherein the print option includes at least one of overlay, watermark, double-sided printing, layout, paper size, paper type, paper source, and resolution options.

16. A network print system comprising:
a server device with a printer driver installed on the server device; and
a plurality of client devices connected to the server device,
wherein a print option of the printer driver is transmitted from the server device to each of the plurality of client devices to set the print options of the plurality of client devices.

17. A network print system comprising:
a server device with a printer driver installed on the server device; and
a plurality of client devices connected to the server device,
wherein a print option of the printer driver and a data file linked to the print option are transmitted from the server device to each of the plurality of client devices to set the print options of the plurality of client devices.

18. A network print system, comprising:
an image forming apparatus;
a plurality of client devices to transmit print data to the image forming apparatus for printing; and
a server arranged on a network between the client devices to receive the print data from the client, to forward the print data to the image forming apparatus, and to transmit a printer driver and a plurality of print options to each of the client devices so as to enable the client devices to transmit the print data.

19. The network print system according to claim 18, wherein the server transmits data related to the print options to each of the client devices along with the print options.

20. The network print system according to claim 18, wherein the server sets a use authority for each of the plurality of print options.

21. The network print system according to claim 18, wherein the server transmits the printer driver and the print options to each of the client devices when the client device connects to the network.
